(19) United States
(12) Patent Application Publication
(10) Pub. No.: US 2017/0253447 A1
(43) Pub. Date: Sep. 7, 2017

(54) PRINTING DEVICE, PRINTING METHOD AND NON-TRANSITORY COMPUTER READABLE MEDIUM

(71) Applicant: FUJI XEROX CO., LTD., Tokyo (JP)

(72) Inventors: Chiemi MIYATA, Yokohama-shi (JP); Noriyuki SUZUMURA, Yokohama-shi (JP); Kazuya TAKAHASHI, Yokohama-shi (JP); Shinichi TAKANO, Yokohama-shi (JP); Kazutoshi KONDO, Yokohama-shi (JP); Daichi TAKAHASHI, Yokohama-shi (JP); Yuta NAKAYAMA, Yokohama-shi (JP); Hosana KIMURA, Yokohama-shi (JP)

(73) Assignee: FUJI XEROX CO., LTD., Tokyo (JP)

(21) Appl. No.: 15/250,495

(22) Filed: Aug. 29, 2016

(30) Foreign Application Priority Data
Mar. 2, 2016 (JP) 2016-039565

(51) Int. Cl. B65H 15/00; G06K 15/00; G06K 15/02

(52) U.S. Cl. CPC B65H 15/00; G06K 15/02; G06K 15/403; G06K 15/4065; B65H 2801/12; B65H 2301/33222; B65H 2301/333

(57) ABSTRACT

There is provided a printing device. In a case where a sheet of a first direction supplied to a printing unit runs out in the middle of printing a certain unit, a sorting controller supplies sheets of a second direction to the printing unit to enable the continuous printing, and in a case where a direction of the image data of the page already held at the time when the sheet of the first direction runs out does not match with the second direction, rotates the image data such that the direction of the image data matches with the second direction, and for the pages in which the print data is not generated at the time when the sheet of the first direction runs out, instructs the generation unit to generate the image data such that the direction of the image data matches with the second direction.

### CROSS-REFERENCE TO RELATED APPLICATIONS

This application is based on and claims priority under 35 USC 119 from Japanese Patent Application No. 2016-039565 filed Mar. 2, 2016.

### TECHNICAL FIELD

The present invention relates to a printing device, a printing method and a non-transitory computer readable medium.

### SUMMARY

According to an aspect of the embodiments of the present invention, there is provided a a printing device including: a generation unit that generates image data of each page from print data; a holding unit that temporarily holds the generated image data until being printed on sheet; a printing unit that prints the image data from the holding unit on a supplied sheet; and a sorting controller that performs a control of sorting a printing result for each unit by alternately changing a direction of the sheets supplied to the printing unit for each unit to and from a first direction and a second direction, in a case of continuously printing the print data having plural units using the sheets of the same size, wherein, in a case where the sheet of the first direction supplied to the printing unit for printing a unit runs out in the middle of printing a certain unit, the sorting controller supplies the sheets of the second direction to the printing unit to enable the continuous printing, and in a case where a direction of the image data of the page already held in the holding unit at the time point when the sheet of the first direction runs out does not match with the second direction, rotates the image data such that the direction of the image data matches with the second direction and transfers the image data to the printing unit, and for the pages in which the print data is not generated by the generation unit yet among the pages in the unit at the time point when the sheet of the first direction runs out, instructs the generation unit to generate the image data such that the direction of the image data matches with the second direction.

### BRIEF DESCRIPTION OF THE DRAWINGS

Exemplary embodiments of the present invention will be described in detailed based on the following figures, wherein:

FIG. 1 is a diagram illustrating an example of a configuration of a printing device in an exemplary embodiment;

FIG. 2 is a diagram illustrating a method of sorting in a basic sorting mode;

FIG. 3 is a diagram illustrating an example of control processing executed by a sorting controller; and

FIG. 4 is a diagram illustrating a specific example of sorting according to the sorting control in the exemplary embodiment.

### DETAILED DESCRIPTION

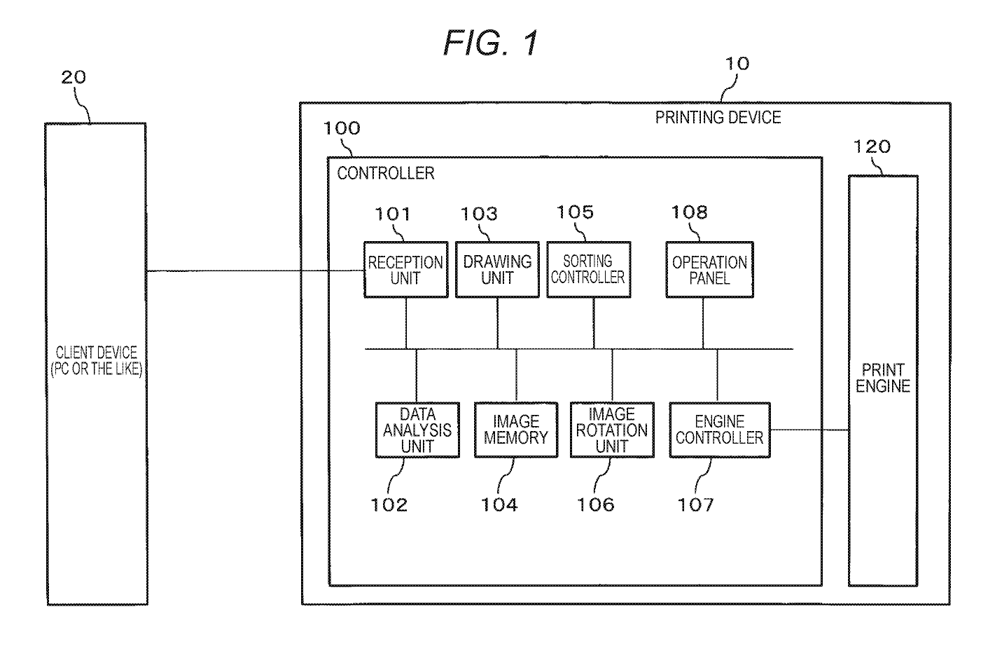

An exemplary embodiment of the printing device according to the present invention will be described with reference to FIG. 1. It is assumed that a printing device 10 described hereinafter is a type of device that does not have a function of sorting using a shift operation of an ejection tray, but realizes the sorting by switching the directions of sheet to be used for each page (for each job). The direction of the sheet is any one of the directions of vertical or horizontal placement of the sheet in a sheet feeding tray, and sometimes the directions are named as long edge feed (LEF) and short edge feed (SEF) instead of vertical placement and horizontal placement.

The printing device 10 in the present exemplary embodiment includes a controller 100 and a print engine 120. The print engine 120 is a mechanical device that prints an image on a sheet with a colorant such as ink and toner. The controller 100 is a control device that controls the print engine 120. The controller 100 receives print data from a client apparatus 20 such as a personal computer (PC) or a backbone system, and causes the print engine 120 to print the image represented by the print data. The backbone system generates a document such as a bill using, for example, information in various databases, and instructs the printing device 10 to print the document.

The controller 100 includes a reception unit 101, a data analysis unit 102, a drawing unit 103, an image memory 104, a sorting controller 105, an image rotation unit 106, an engine controller 107, and an operation panel 108.

The reception unit 101 receives the print data received by the client apparatus 20. The print data is written in a page description language (PDL).

The client apparatus 20 may be a device having functions of acquiring performance information from the printing device 10 at the time of starting printing, and in a case where the performance information satisfies a certain condition (for example, a memory capacity is equal to or less than a threshold value) and in a case where the number of printing copies is a multiple amount, repeatedly transmitting the print data to the printing device 10 as much as the number of copies. In this case, the reception unit 101 repeatedly receives the print data from the client apparatus 20 as much as the number of copies.

The data analysis unit 102 analyzes the print data (and print setting data accompanied thereto, if any) received from the reception unit 101, and generates an internal command for drawing. In addition, the data analysis unit 102 determines print settings such as a size and direction of the sheet used in printing and whether the printing mode is duplex printing or simplex printing using the result of analysis, and transfers the determined print settings to the engine controller 107.

The drawing unit 103 draws image data of each page on the image memory 104 according to the internal command for drawing output from the data analysis unit 102. The image memory 104 is a memory storing the image data and has a capacity in which generally about one job of image data amount can be stored. The image memory 104 functions as a page buffer that holds the image data of each page from the time of being read out by the image rotation unit 106 or the engine controller 107 to the time of being printed.

The sorting controller 105 performs the control of sorting the printed sheet for each job or for each copy. In a case of the jobs designating the printing of multiple numbers of copies, since the sheet size for each copy is the same, it is necessary to sort the printing result for each copy. In addition, in a case the jobs designating the printing on the sheet having the same size is continued, it is also necessary to sort the printing result for each copy. However, in both cases, if a user states that the sorting is not necessary, the sorting is not performed.

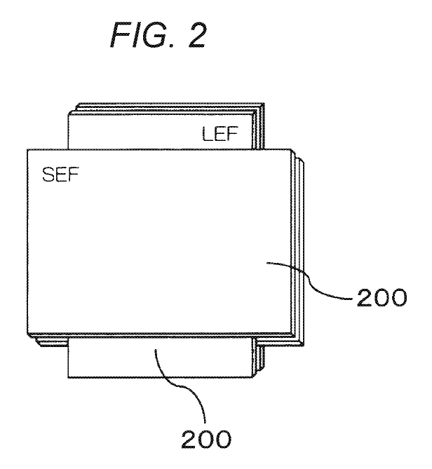

In a basic sorting mode (referred to as “basic sorting mode”), the sorting controller 105 realizes the sorting by alternately feeding the sheet from two different sheet feed units that accommodate sheet of which the sizes are the same and the directions are different from each other among a multiple number of sheet feed units included in the print engine 120. The direction of the sheet includes the vertical placement (LEF) and the horizontal placement (SEF). As illustrated in FIG. 2, in an alternate feed sorting mode, the directions of the printed sheets 200 alternately change for each unit, and thus, the sorting for each unit is realized.

In addition, in a case where a sheet run-out occurs during the execution of the basic sorting mode, the sorting controller 105 performs the sorting in an exceptional sorting mode. In the exceptional sorting mode, the printing is continuously performed using the sheets fed from the sheet feed unit in which the sheets are remained, and the sorting for each unit is performed based on whether the printing result is output with a face-up output or a face-down output. In the face-up output, the printing surface of the printing result (in the ordinary single-sided printing) is on the front surface, and in the face-down output, the printing surface of the printing result is on the back surface. The result of sorting in the exceptional sorting mode for each unit is distinguished from each other according to whether the printing surface is the front surface or the back surface. The exceptional sorting mode will be specifically described below.

The image rotation unit 106 rotates the image of the page in the image memory 104, and writes the rotated image back to the image memory 104. This writing back is necessary since the engine controller 107 acquires the image data from the image memory 104 (buffer) and sends the image data to the print engine 120. In the basic sorting mode, since the direction of the sheets is alternately changed for each unit, there occurs a case where the direction of the sheets does not match with the direction of the image drawn on the image memory 104 as the designation in the print data. In this case, the direction of the image data is made to match with the direction of the sheets by the image rotation unit 106 rotating the image data by 90° (or 270°).

The engine controller 107 causes the print engine 120 to print the image data generated by the drawing unit 103 (and rotated by the image rotation unit 106, if necessary) and accumulated in the image memory 104. Here, the engine controller 107 designates the sheet feed unit as the sheet feeding source to the print engine 120 according to the print setting obtained by the data analysis unit 102 or the indication from the sorting controller 105. The print engine 120 prints the image data received from the engine controller 107 on the sheets fed from the sheet feed unit designated by the engine controller 107.

The operation panel 108 is a user interface mechanism for a local operation of the printing device 10, and includes a screen displaying information such as an operation state of the printing device 10 and devices such as a button or a touch panel for receiving the instructions input from the user.

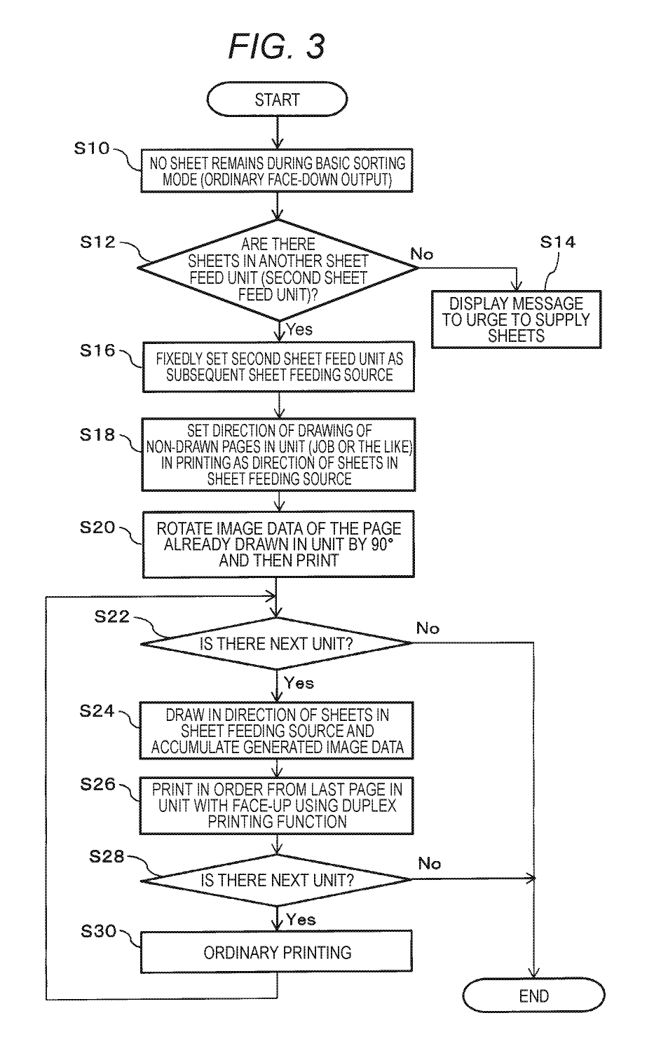

Next, a flow of controlling the sorting in the exceptional sorting mode will be described with reference to FIG. 3.

The processing illustrated in FIG. 3 starts in a case where the sheet in the sheet feed unit as the sheet feeding source runs out when the printing is executed while the sorting is performed in the basic sorting mode (S10). In this case, the sorting controller 105 determines whether or not there are sheets in another sheet feed unit (referred to as a “second sheet feed unit”) which is different from the sheet feed unit (referred to as a “first sheet feed unit”) in which currently the sheet run-out occurs among the two sheet feed units using the basic sorting mode (S12). In a case where there is no sheet in the sheet feed unit either, the sorting controller 105 displays a message on the screen of the operation panel 108 to urge the user to supply the sheets to both of the two sheet feed units (S14)

In a case where it is determined that there are sheets in the second sheet feed unit in S12, the sorting controller 105 sets the subsequent sheet feeding source for printing each unit as the second sheet feed unit (S16).

In addition, the sorting controller 105 causes the direction of the drawing of the image by the drawing unit 103 to match with the direction of the sheets in the second sheet feed unit which is the sheet feeding source (S18). For example, at the time point when the sheet run-out occurs in the basic sorting mode, in a case where the drawing unit 103 draws the image in the direction indicated in the print data, the drawing unit 103 is set so as to draw the image after rotating the image by 90° (or 270°) in S18. Conversely, in a case where the drawing unit 103 is set so as to draw the print data after rotating the image by 90° (or 270°) at the time point when the sheet run-out occurs, the drawing unit 103 is set so as to draw according to the indication in the print data (without rotating the image) in S18. According to the setting in S18, among the units (jobs or the like) in printing at the time point when the sheet run-out occurs, a group of pages of which the image data has not started to be drawn yet is drawn in the direction matching with the direction of the sheets in the second sheet feed unit.

In addition, the sorting controller 105 causes the image rotation unit 106 to rotate the image data of the pages already drawn in the image memory 104 but not printed yet at the time point when the sheet run-out occurs among the units (jobs or the like) in printing at that time point, by 90° (or 270°) (S20). In this way, the direction of the image data of each page is adapted to the direction of the sheets from the second sheet feed unit which is a new sheet feeding source.

According to S18 and S20, among the units of sheet run-out occurring, each page not printed yet at the time of sheet run-out occurring can be printed in a right direction on the sheet supplied from the second sheet feed unit. The execution order of the steps in S16 to S20 in FIG. 3 is just an example. The execution order of the steps may be any order.

When printing for all the pages in the unit of the sheet run-out occurring is finished, the sorting controller 105 determines whether or not there is a next unit (jobs or the like) (S22), and ends the processing, if no. In a case where there is a next unit, the sorting controller 105 instructs the drawing unit 103 to draw each page in the “next unit” in the direction matching with the direction of the sheets in the second sheet feed unit which is the sheet feeding source (S24). The printing does not start until the drawing of the last page in the unit is finished, and thus, the image data of all the pages in the unit is accumulated in the image memory 104. The sorting controller 105 instructs the engine controller 107 to output the printing result of the image data in each page faced-up using the duplex printing function (S26). Here, for example, the image data in the page may be printed on the back surface while the front surface being empty by the duplex printing operation. In this way, the printing result is output in the face-up state. In the printing device 10 in this example, the output state of ordinary single-sided printing is face-down, and it is assumed that output state up to S20 is face-down.

However, by outputting the printing result in reverse to the ordinary state by simply switching the output state to the face-up, the order of pages in a bundle of printing results becomes reverse. Therefore, in S26, the sorting controller 105 instructs the engine controller 107 to supply the image data of each page in the unit in the image memory 104 to the print engine 120 in reverse order of the correct page order, that is, in order from the last page. In this way, the order of pages in the printing results in the face-up becomes the correct order.

Thereafter, the sorting controller 105 determines whether or not there is a non-processed next unit (jobs or the like) (S28), and if yes, causes the drawing unit 103 to ordinarily process the group of internal commands for drawing of the “next unit” such that the ordinary printing can be performed (S30). In this way, the printed output of this unit becomes ordinary face-down output.

Subsequently, returning to S22, the sorting controller 105 determines whether or not there is a non-processed next unit, and repeats the processes subsequent to S24, if yes. In S22 or S28, in a case where it is found that there is no non-processed next unit, the sorting controller 105 ends the control of sorting.

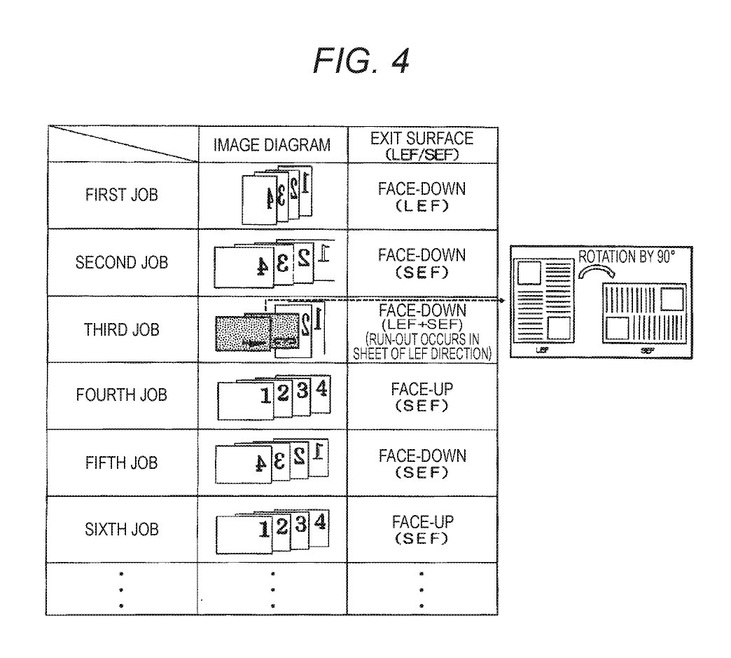

A specific example of sorting processing illustrated in FIG. 3 is illustrated in FIG. 4. In the example in FIG. 4, in a case of printing the same document in a multiple number of copies, it is assumed that an instruction is given from the client apparatus 20 to the printing device 10 with each copy as an individual job. In the illustrated example, until the starting time point of the third job, sorting is performed in a form of alternately switching the direction in the sheet such as LEF or SEF according to the basic sorting mode. In addition, until this time point, all of the front or back directions of the print output are the ordinary face-down output. Regarding the third job, printing is performed on the sheets of LEF direction according to the basic sorting mode up to the second page, and then, the LEF sheet run-out occurs after printing the second page. At this time, since sheets of another direction (SEF) remain (the determination result in S12 is YES), the remaining pages in the third job are printed using the sheets of SEF direction, and the printing result is output in the ordinary face-down output. Regarding the next fourth job, since there are only the sheets of SEF direction, the face-up output which is in reverse of the ordinary state is performed. At this time, the order of printing the pages is the reverse order (descending order) to the order of pages in the job (ascending order) such that the order of pages in the printing result in the face-up output becomes correct. Similarly, regarding the pages subsequent to the fifth job, the face-down output and the face-up output are alternately repeated for each job using the sheets of SEF direction.

An embodiment of the invention is described as above.

In the exemplary embodiment, during the execution of the basic sorting mode, when the sheet run-out occurs in the middle of printing a certain unit (a job or the like), the printing is continued using the sheets of another direction. In this case, among pages in the unit, the drawing direction is adjusted to the direction of the sheets direction by rotating the image of the page already drawn and stored in the image memory 104 by 90°, and rotating the drawing direction by 90° for the non-drawn image of the page. According to this control, the drawing direction can be maintained up to the last page in the unit, and regarding the group of non-drawn pages in the unit for which the sheet run-out occurs, the processing speed increases compared to the case of rotating the printing resulted image by 90° as much as the reduced duplicated efforts of rotating the image by 90° after drawing.

In addition, in the present exemplary embodiment, the sorting for each unit is performed by alternately changing the direction of the front and back surfaces of the printing result for each page after the sheet run-out (by alternately and repeatedly changing the face-up output and face-down output). In this method, sorting for each unit can be performed without inserting any particular separator sheet.

The functions of the controller 100 exemplified above are realized by causing a computer to execute the program representing the functions of each of those units. Here, the computer includes a circuit configuration in which, as hardware, for example, a microprocessor such as a CPU, memory (primary storage) such as a random access memory (RAM) and a read only memory (ROM), a controller that controls a fixed storage device such as a hard disk drive (HDD) and a solid state drive (SSD), various input-output (I/O) interfaces, a network interface that performs the control for the connection to a network such as a local area network are connected to each other via, for example, a bus. In addition, for example, a disk drive for reading and/or writing with respect to a portable disk recording medium such as a CD or a DVD, and a memory reader/writer for reading or writing with respect to a portable non-volatile recording medium of various standards such as a flash memory, may be connected to the bus via the I/O interface. The program in which the processing content of each functional module exemplified above is described is stored in a fixed storage device such as the HDD via the recording medium such as the CD or the DVD or via communication unit such as a network, and then, is installed in the computer. The program stored in the fixed storage device is read out to the RAM and executed by the microprocessor such as the CPU, and then, the group of functional modules described above is realized.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printing device comprising:
a generation unit that generates image data of each page from print data;
a holding unit that temporarily holds the generated image data until being printed on sheet;
a printing unit that prints the image data from the holding unit on a supplied sheet; and
a sorting controller that performs a control of sorting a printing result for each unit by alternately changing a direction of the sheets supplied to the printing unit for each unit to and from a first direction and a second direction, in a case of continuously printing the print data having a plurality of units using the sheets of the same size,
wherein, in a case where the sheet of the first direction supplied to the printing unit for printing a unit runs out in the middle of printing a certain unit, the sorting controller supplies the sheets of the second direction to the printing unit to enable the continuous printing, and in a case where a direction of the image data of the page already held in the holding unit at the time point when the sheet of the first direction runs out does not match with the second direction, rotates the image data such that the direction of the image data matches with the second direction and transfers the image data to the printing unit, and for the pages in which the print data is not generated by the generation unit yet among the pages in the unit at the time point when the sheet of the first direction runs out, instructs the generation unit to generate the image data such that the direction of the image data matches with the second direction.

2. The printing device according to claim 1, wherein, for the pages subsequent to the page being printed at the time point when the sheet of the first direction runs out, the sorting controller alternately changes a sheet ejection aspect of the printing result by the printing unit on the sheets of the second direction to and from a face-up ejection and a face-down ejection for each page.

3. A printing device comprising:
a printing unit that prints image data on a supplied sheet; and
a sorting controller that performs a control of sorting a printing result for each unit by alternately changing a direction of the sheets supplied to the printing unit for each unit to and from a first direction and a second direction, in a case of continuously printing the print data having a plurality of units using the sheets of the same size,
wherein, in a case where the sheet of the first direction supplied to the printing unit for printing a unit runs out in the middle of printing a certain unit, the sorting controller supplies the sheets of the second direction to the printing unit to enable the continuous printing, and for the pages subsequent to the page being printed at the time point when the sheet of the first direction runs out, alternately changes a sheet ejection aspect of the printing result by the printing unit on the sheets of the second direction to and from a face-up ejection and a face-down ejection for each page.

4. A non-transitory computer readable medium storing a program that causes a computer to function as:
a holding unit that temporarily holds image data of each page generated from print data until being printed on a sheet;
a print controller that supplies the image data from the holding unit to a printing unit; and
a sorting controller that performs a control of sorting a printing result for each unit by alternately changing a direction of the sheets supplied to the printing unit for each unit to and from a first direction and a second direction, in a case of continuously printing the print data having a plurality of units using the sheets of the same size,
wherein, in a case where the sheet of the first direction supplied to the printing unit for printing a unit runs out in the middle of printing a certain unit, the sorting controller supplies the sheets of the second direction to the printing unit to enable the continuous printing, and in a case where a direction of the image data of the page already held in the holding unit at the time point when the sheet of the first direction runs out does not match with the second direction, rotates the image data such that the direction of the image data matches with the second direction and transfers the image data to the printing unit, and for the pages in which the print data is not generated by the generation unit yet among the pages in the unit at the time point when the sheet of the first direction runs out, instructs the generation unit to generate the image data such that the direction of the image data matches with the second direction.

5. A non-transitory computer readable medium storing a program that causes a computer to function as:
a print controller that supplies image data of each page generated from print data to a printing unit; and
a sorting controller that performs a control of sorting a printing result for each unit by alternately changing a direction of the sheets supplied to the printing unit for each unit to and from a first direction and a second direction, in a case of continuously printing the print data having a plurality of units using the sheets of the same size,
wherein, in a case where the sheet of the first direction supplied to the printing unit for printing a unit runs out in the middle of printing a certain unit, the sorting controller supplies the sheets of the second direction to the printing unit to enable the continuous printing, and for the pages subsequent to the page being printed at the time point when the sheet of the first direction runs out, alternately changes a sheet ejection aspect of the printing result by the printing unit on the sheets of the second direction to and from a face-up ejection and a face-down ejection for each page.
